(19) United States
(12) Patent Application Publication
(10) Pub. No.: US 2004/0239979 A1
(43) Pub. Date: Dec. 2, 2004

(54) Method and systems for providing an email engine for a printing device

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/447,842

(22) Filed: May 29, 2003

(51) Int. Cl. G06F 15/00; H04N 1/00

(52) U.S. Cl. 358/1.15; 358/402

(57) ABSTRACT

A method of providing an email engine for a printing device includes attaching a memory module storing the email engine to a printing device consumable.

### BACKGROUND

With a personal computer and an appropriate software package, a user can produce virtually any type of document that may be desired. For example, word processing software is used to produce text documents. Graphic design or computer-aided design software can be used to produce diagrams, charts, graphs, designs, etc. Spreadsheet software allows a user to manage large amounts of financial and other types of information. Database software similarly allows a user to manage various databases of information such as, client contact information, address and phone number information or “to do” items.

Frequently, it is desirable to generate a hardcopy of a document or data set that is produced or stored on a personal computer. A hardcopy may be desired, for example, for record keeping purposes or to share with another party. Consequently, a wide variety of printers and printing devices have been developed that can receive a print job from a host computer and produce a hardcopy of the document or data represented by that print job. In order to save space, particularly in home offices, many users employ a multi-function peripheral (MFP) with a host computer. A multi-function peripheral is a device that combines some form of printer with one or more of the following: a scanner, a copier, or a facsimile machine.

As used herein and in the appended claims, the terms “printer” and “printing device” are defined to mean any device that produces a hardcopy from electronic data, including, but not limited to, laser printers, inkjet printers, dot matrix printers, plotters, facsimile machines, digital copiers, photocopiers, multi-function peripherals, and the like. A printer or printing device may produce images on a variety of print media that are in color or are monochromatic.

The term “print job” is defined as data that has been specifically formatted for submission to a particular printer from which the printer can generate a hardcopy representing an underlying data set from which the print job was created. Most personal computers include programming that will be referred to generally as a “printer driver.” A printer driver is a piece of software or firmware that receives data or a document to be printed from an application running on the computer. The printer driver formats the data for use by a corresponding printer, i.e., creates a print job, and then transmits the print job to the printer. Using the print job, the printer can produce a hardcopy of the underlying data or document.

In order to produce hardcopy documents, a printer or printing device uses supplies of materials that are “consumed” as documents are printed. Such consumables include, for example, toner and print media. As used herein and in the appended claims, “toner” shall be broadly defined to include any material that is selectively distributed by a printer or printing device on a print medium to form an image. Thus, “toner” includes, but is not limited to, ink, toner, colorant, printing fluid, etc. “Print media” or a “print medium” shall be broadly defined as any medium on which a printer or printing device prints an image. For example, types of “print media” include, but are not limited to, paper, cardboard, card stock, transparencies, vinyl, etc.

As used herein and the appended claims, the term “consumable” shall be defined to mean any material consumed by a printing device to produce hardcopy documents. For example, a consumable may be toner and the disposable cartridge or container that contains the toner in the printing device. A consumable may also be a stack or supply of print media. In addition to toner and print media, a “consumable” may be any part or portion of a printer or printing device that is periodically replaced to allow the printer or printing device to continue producing printed hardcopy documents.

Clearly, some effort is required to monitor a printer or printing device and replace or re-supply a consumable as needed. Some printers and printing devices may have some mechanism for alerting an operator that replacement of a consumable is required or that other attention must be given to the printer, e.g., due to a paper jam, etc. These mechanisms may include indicator lamps on the printer, messages displayed on a display device of the printer and audible alert sounds made by the printer. In some instances, the printer may be able to send a message to a printer driver running on a connected host computer indicating that a consumable needs replacement or the printer otherwise requires user attention.

### SUMMARY

A method of providing an email engine for a printing device includes attaching a memory module storing the email engine to a printing device consumable.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a block diagram illustrating an email engine stored on a memory module according to one embodiment of the present invention.

FIG. 2 is a block diagram illustrating a printing device consumable with an affixed memory module according to one embodiment of the present invention.

FIG. 3 is a block diagram of the consumable and memory module of FIG. 2 in use by a printing device according to one embodiment of the present invention.

FIG. 4 is a flowchart illustrating a method of providing an email engine for a printing device according to one embodiment of the present invention.

FIG. 5 is a flowchart illustrating a method of providing an email engine for a printing device according to an alternative embodiment of the present invention.

FIG. 6 is a block diagram illustrating a system for customizing email engines on memory modules according to one embodiment of the present invention.

Throughout the drawings, identical reference numbers designate similar, but not necessarily identical, elements.

### DETAILED DESCRIPTION

This specification describes a method and device for installing an email engine on a printer or printing device. As used herein and in the claims, the phrase “email engine” refers to a set of computer-readable instructions (e.g., software or firmware) for providing a printer or printing device with the function or capability of sending data or information via email. This email engine can then be used by the printing device to transmit messages alerting a user or an attendant to conditions at the printing device or indicating that the printing device requires attention. Such a message may, for example, alert the user or attendant to clear a paper jam, or indicate that the printer is in need of replacement or a re-supply of a consumable such as an ink or toner cartridge, paper or other print medium, replaceable parts, etc. The described method includes storing an email engine on a memory module attached to a printing device consumable and uploading that email engine or portions of the email engine to the printing device for storage in memory and/or for execution when the consumable is loaded into the printing device.

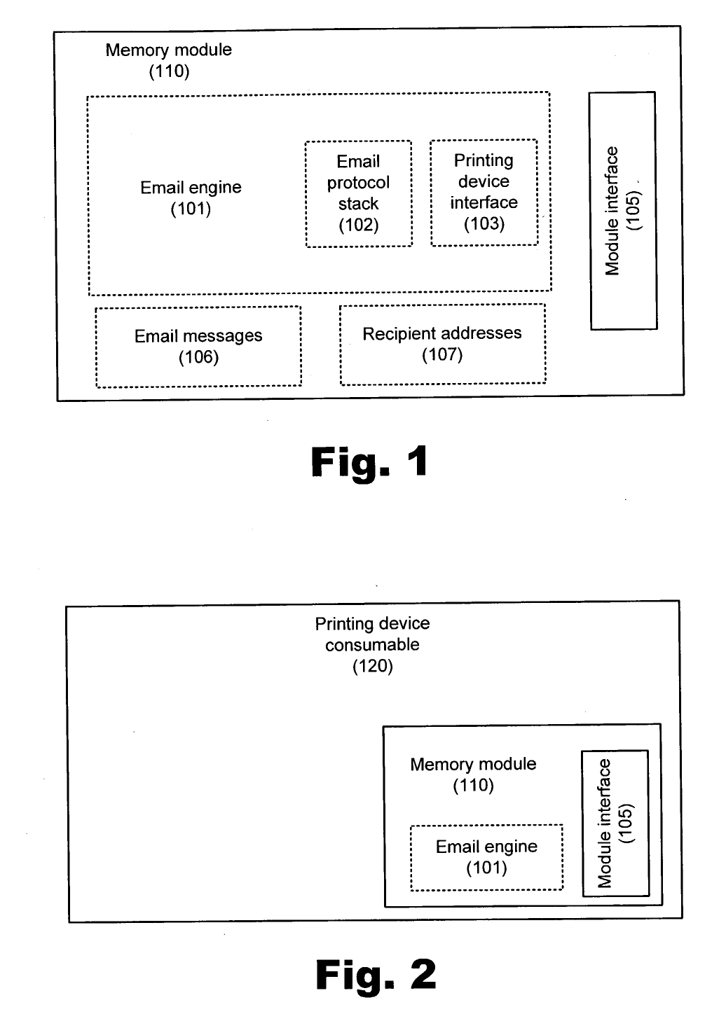

As shown in FIG. 1, an email engine (101) is stored on a memory module (110). The module (110) is a non-volatile memory device, for example, Flash memory, and includes a module interface (105) through which the data stored on the module (110), including the email engine (101), can be accessed. The module interface (105) can be a wired or wireless interface. As will be described below, the module interface (105) interfaces the memory module (110) with a printing device so that the printing device can upload or use the email engine (101) and other data items on the memory module (110).

In general, an email engine (101) is a set of computer-readable instructions that enable a computer or other processing device, such as a printer or printing device, to send email messages to particular email addresses though a network to which the processing device is connected. The network may be a local area network (LAN), a wide area network (WAN) and/or the Internet. The email engine (101) may be written in variety of different computer languages, e.g., Java, C++, COM, etc.

The email engine (101) on the memory module (110), when executed by a printing device, provides the printing device with the ability to transmit and/or receive email messages over a network to which the printing device is connected. In the illustrated example, the email engine includes an email protocol stack (102) and an email engine interface (103). The email protocol stack (102) determines how the email engine (101) transmits email message. The protocol stack (101) may operate according to any present or future email protocol whether standard or proprietary, such as, Post Office Protocol (POP) or Internet Message Access Protocol (IMAP). The email engine interface (103), as will be explained in more detail later, can be uploaded to a printing device to allow the printing device to access and execute the email engine (101) without uploading the entire email engine (101) to printing device memory.

As indicated, the email engine (101) can be used by a printing device to automatically transmit email messages to alert a user or attendant as to the condition of the printer, e.g., the need for attention to clear a jam or add or replace a consumable, etc. In such an embodiment, the email protocol stack (102) provides computer-readable instructions for selecting one or more stored, pre-written email messages and sending the email messages to one or more email addresses. The pre-written email messages (106) and/or the recipient addresses (106) can be stored on the memory module (110) or may be stored in the memory of the printing device.

As shown in FIG. 2, the memory module (110) is attached to a printing device consumable (120) that will be provided to, or placed in, a printer or printing device. As indicated above, a “consumable” is any material, including toner or print media, consumed by a printing device to produce hardcopy documents. In addition to toner and print media, a “consumable” may be any part or portion of a printer or printing device that is periodically replaced to allow the printer or printing device to continue producing printed hardcopy documents. The memory module (110) may, for example, be attached to the disposable cartridge or container that holds the toner in the printer. The memory module (110) may also be attached to the stack or supply of print media or to some other consumable part of the printer.

The module interface (105) then provides communication between the printer and the memory module (110) so that the printer can upload or use the email engine (101) and other data items on the memory module (110). The printer may upload the email engine (101) and other data items on the memory module (110) to a memory unit in the printer or, alternatively, the printer may execute the email engine (101) and use the other data items (e.g., 106, 107) directly from the memory module (110).

As indicated, the module interface (105) may be a wired or wireless interface for transferring data between the memory module (110) and a printing device. For example, the module interface (105) may comprise input/output lines or pins for allowing wired transmission and reception of data between the memory module (110) and a host printing device. Alternatively, the module interface (105) may also include an infrared transceiver to send and receive data wirelessly with an infrared signal. In still another example, the module interface (105) may include an antenna coil to send and receive data wirelessly using, for example, a radio frequency (RF) signal. For example, a Radio Frequency Identification (RFID) method and protocol may be used to transmit data between a memory module (110) and a printing device. Using a wireless method, as described herein, is advantageous because no physical contact between the memory module (110) and printing device is required, i.e., the physical design of a printing device and corresponding consumables is facilitated.

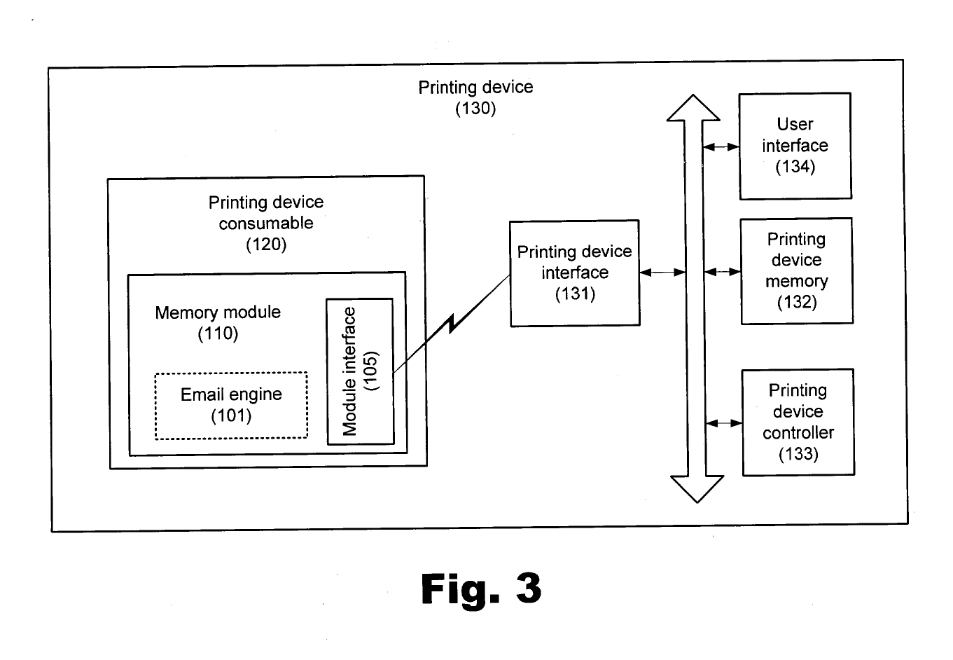

FIG. 3 is a block diagram illustrating a consumable (120) that has been installed in, or supplied to, a printer or printing device (130). The consumable (120) bears a memory module (110) storing an email engine (101) for use by the printing device (130) as described above.

As shown in FIG. 3, the printing device (130) includes a printing device interface (131) that interfaces with the module interface (105) on the memory module (110). The printing device interface (131) will correspond to the module interface (105) to allow communication between the memory module (110) and the printing device (130). Consequently, the printing device interface (131) may be a receptacle for receiving the pins or wired traces of a wired module interface (105). Alternatively, the printing device interface (131) may be a wireless transceiver for communicating with a wireless transceiver of the module interface (105). In one embodiment, the memory module (110) may comprise an RFID memory tag as part of the module interface (105), and the printing device interface (131) may comprise an RFID interrogator. Alternatively, the module interface (105) and printing device interface (131) may, for example, be an infrared interface. The printing device interface (131) and the module interface (105) will be referred to collectively as the interface (105, 131).

The printing device (131) can upload some or all of the email engine (101) and any other data items on the memory module (101) through the interface (105, 131). The email engine (101) and any other uploaded data items may be stored in the memory unit (132) of the printing device (130). This printing device memory (132) may comprise both volatile and non-volatile memory, both writable and read-only memory. If the email engine (101) is uploaded to the memory unit (132), the email engine (101) maybe stored in non-volatile memory so as to be available each time the printing device (130) is powered up.

Alternatively, the interface (105, 131) can allow the printing device (131) to execute or use the email engine (101) and other data items directly from the memory module (110) without uploading or storing the entire engine (101) in the printing device memory unit (132). This is done by uploading the email engine interface (103) from the memory module (110) and using the email engine interface (103) to execute the email engine (101) from the memory module (110). In such an embodiment, the email engine interface (103) may be uploaded to volatile or non-volatile memory in the printing device memory unit (132). If the email engine interface (103) is kept only in volatile memory, the email engine interface (103) will be uploaded each time the printing device (130) is powered up. However, this will reduce the demands on non-volatile memory.

A printing device controller or processor (133) controls the operation of the printing device (130) according to firmware stored in the printing device memory (132). The printing device controller (133) will determine whether to upload the entire email engine (101), just the email engine interface (103) or other data items from the memory module (110) for storage in the memory unit (132). As indicated, if the email engine (101) is uploaded and stored in the memory unit (132), the controller (133) can then execute the email engine (101) to send email messages, for example, alerting designated recipients of conditions in the printing device (130). Alternatively, the controller (133) may execute the email engine (101) directly from the memory module (110).

The printing device (130) also includes a user interface (134) to allow a user or attendant to control operation of the printing device (130). Such a user interface (134) may include, for example, a display device such as a liquid crystal display (LCD) and a keypad, buttons or other device for allowing a user to input or select data, such as selecting menu items or responding to queries. Alternatively, the user interface (134) may include a touch screen that both displays data and receives user input.

In some embodiments, the printing device (130) may automatically upload, store or use programming or data from an interfaced memory module (110). Alternatively, the user interface (134) can allow the operator of the printing device (130) to control whether the printing device (130) uploads, stores or uses any of the programming or data available from an interfaced memory module (110) on a consumable (120).

Once the email engine (101) is available to the printing device (130), either stored in the printing device memory (132) or available directly from an interfaced memory module (110), the email engine (101) can be used to send emails messages to designated recipients indicating conditions relating to the printing device (130). Such emails may be sent in response to trigger events. For example, an occurrence of low toner or a paper jam, etc., may be included as “trigger events” about which a user or attendant would be notified by email. The occurrence of a paper jam is another possible trigger event for which a user might want to receive an email notice. Depletion of the supply of paper or other print medium is another possible trigger event. Any event of which a printer user wishes to be notified may be a trigger event.

A list of possible trigger events can be included in the email engine (101) so that a user can select those trigger events for which an email notification should be generated. The user may do so through the user interface (134) of the printing device (130) while the email engine (101) is being executed by the controller (133). For some users, however, this may be too complicated. Consequently, the email engine (101) may be programmed to automatically respond to a list of particular “default” trigger events. The user may then deselect, if desired, any of the default trigger events.

The user may also be given the option of defining, at least in part, what constitutes a trigger event. For example, a low toner supply is a condition that requires attention to keep the printing device (130) operational. Thus, when the supply of toner begins to run out, the user or attendant may wish to receive an email from the printing device (130) indicating that the supply of toner is low. However, different users may define a low toner condition differently. For example, a particular user may want to configure the email engine to send an email warning when 5000 pages worth of toner remains. Another user may choose to be notified when 1000 pages worth of toner remains.

In summary, some embodiments of the email engine (101) can be configured to generate the desired email notification upon the occurrence of any trigger event. As indicated, the trigger events to be recognized can be selected from a list of possible trigger events provided with the email engine (101). This may include specifying quantities or other parameters that help define the trigger event, such as the pages that can be printed with the current remaining toner supply. Alternatively or additionally, the email engine (101) can be pre-programmed to recognize certain default trigger events and automatically respond by generating an email notification.

Once the printing device (130) has the email engine (101) and appropriate trigger events have been defined, the controller (133) monitors the printing device (130) operation for the occurrence of any of the designated trigger events. The printing device controller (133) identifies trigger events when they occur and uses the email engine (101) stored on the memory module (110) or in printing device memory (132) to send appropriate email alerts in response to the occurrence of the trigger event. The programming for performing this monitoring function may be part of the email engine (101) or may be separate firmware in the printing device (130) or on the memory module (120).

The email notification generated by the printing device (130) with the email engine (101) may be sent to the immediate user of the printing device (130), a designated printing device attendant or even a third-party supplier responsible for maintenance of the printing device. For example, a printing device may be provided to an enterprise on a lease basis, such as a Cost-per-Page (CPP) contracts in which the user is charged for each printed page rather than for the printing device itself. Under such a lease, the owner of the printing device, rather than the user or leasee of the printing device, may be responsible for maintaining the printing device, including service, parts, toner, etc., for the length of the contract. Therefore, when a printing device under CPP contract or similar lease experiences a trigger condition, such as having a low toner supply, an email notifying the owner of the printing device may be sent. The printing device can then be serviced as needed without the user, i.e., the party leasing the printing device, being involved or even aware of the need for service to the printing device and the consequent service provided.

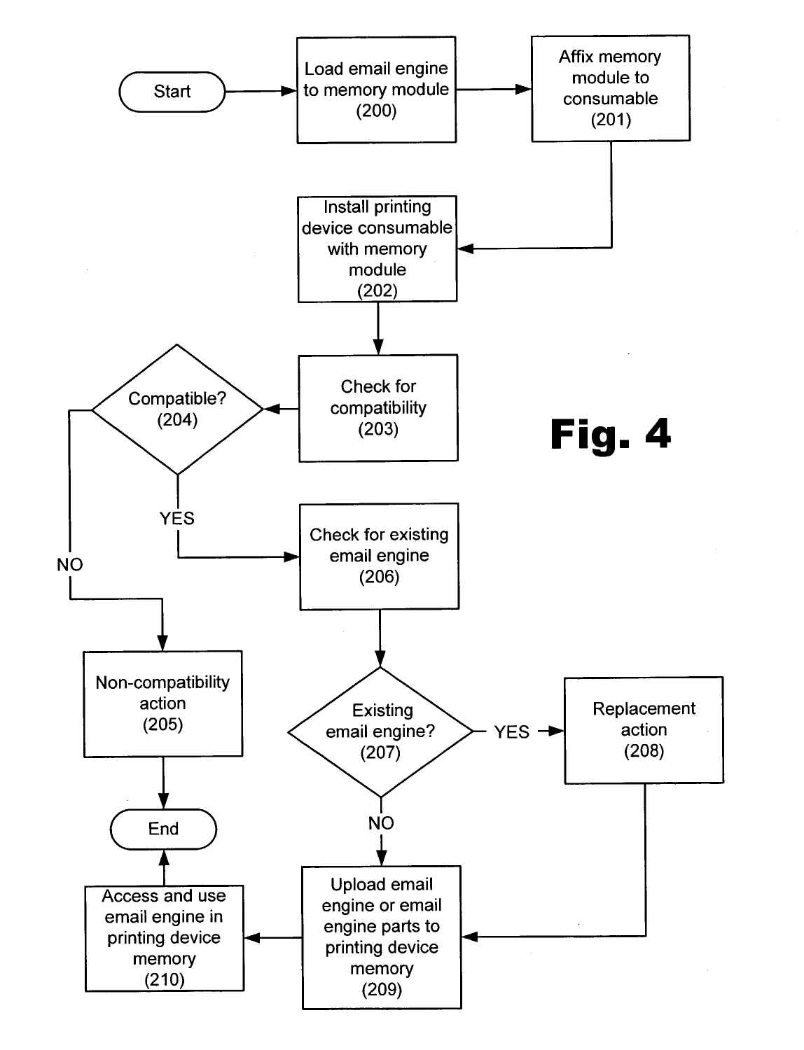

FIG. 4 is a flowchart illustrating a method of providing an email engine for a printing device. As shown in FIG. 4, an email engine is loaded on a memory module (step 200). The memory module may be any memory device capable of storing computer-readable instructions, including, but not limited to, Flash memory, battery-backed random access memory (RAM), etc. The memory module is then attached or affixed to a consumable that will be used by or in a printing device (step 201).

After a printing device consumable, e.g., a toner cartridge, etc., with the attached memory module has been installed in a printing device (step 202), a check for hardware/software compatibility may be performed (step 203). If the email engine is not compatible with the hardware/software of the host printing device (determination 204), a non-compatibility action is carried out (step 205). For example, a non-compatibility action may include a notice appearing on a computer monitor or a display device of a user interface on the printing device indicating that the email engine available is incompatible with the printing device. Additionally, information on firmware upgrades or other actions that may fix the compatibility problem may be displayed along with the indication of incompatibility.

If the email engine is compatible with the printing device (determination 204), a check for an existing email engine may be performed (step 206). Some higher-end printing devices may already include an email engine, embedded web-browser, etc., to enhance the functionality of the printing device. If another email engine already exists on the printing device (determination 207), a replacement action may be performed (step 208). For example, a replacement action (step 208) may include overwriting the existing or previous email engine in the memory of the printing device with the new email engine available from the memory module on the consumable (step 209).

Alternatively, a replacement action (step 208) may comprise uploading only certain segments of a new email engine, e.g., upgrades, customized additions, etc., thereby upgrading or enhancing the existing email engine. This may render the previous email engine a functional replica of the email engine provided on the memory module on the consumable. User input through the user interface of the printing device may be requested before an existing email engine is replaced, in whole or in part, by an email engine that is available through a memory module on a consumable. Additionally, a password or other confirmation of authority may be required to initiate replacement, in whole or in part, of an existing email engine in the printing device.

As part of the replacement action (step 208), or if no email engine presently exists on a printing device (determination 207), all or part of the email engine included with the printing device consumable may be uploaded to printing device memory (step 209). After the new email engine has been installed, the email engine may be accessed in printing device memory and used (step 210) as described above.

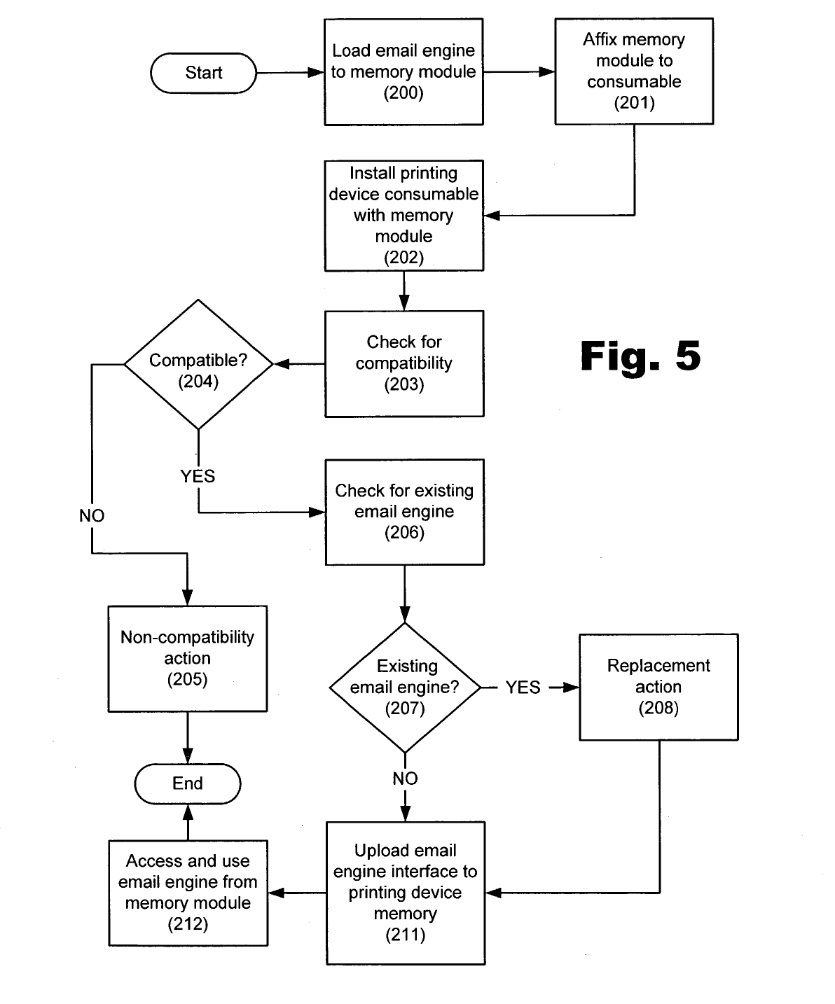

FIG. 5 is a flowchart illustrating another method of providing an email engine for a printing device. FIG. 5 is similar to FIG. 4. As shown in FIG. 5, an email engine is loaded on a memory module (step 200). The memory module may be any memory device capable of storing computer-readable instructions. The memory module is then attached or affixed to a consumable that will be used by or in a printing device (step 201).

After a printing device consumable with the attached memory module has been installed in a printing device (step 202), a check for hardware/software compatibility may be performed (step 203). If the email engine is not compatible with the hardware/software of the host printing device (determination 204), a non-compatibility action is carried out (step 205). For example, a non-compatibility action may comprise a notice indicating that the email engine available is incompatible with the printing device. Additionally, information that may be used to fix the compatibility problem may be displayed along with the indication of incompatibility.

If the email engine is compatible with the printing device (determination 204), a check for an existing email engine may be performed (step 206). If another email engine already exists on the printing device (determination 207), a replacement action may be performed (step 208). As above, the replacement action (step 208) may include disabling or erasing the existing or previous email engine in the memory of the printing device in favor of the new email engine available from the memory module on the consumable (step 209). User input through the user interface of the printing device may be requested before an existing email engine is replaced in favor of an email engine that is available through a memory module on a consumable. Additionally, a password or other confirmation of authority may be required to initiate replacement of an existing email engine in the printing device.

As part of the replacement action (step 208), or if no email engine presently exists on a printing device (determination 207), an email engine interface is uploaded to the printing device memory (211). As illustrated above in FIG. 1, the email engine interface is a component of the email engine that allows a printing device to communicate with and execute the email engine while the engine remains on the memory module on the consumable and is not loaded or installed in the memory unit of the printing device. After the email engine interface has been stored on the printing device, the email engine interface can be used to access and execute the email engine on the memory module (step 212), without having to copy the email engine into the memory of the printing device.

The process of FIG. 5 differs from the process of FIG. 4 in that the process of FIG. 4 stores the email engine in printing device memory, while the process of FIG. 5 does not. Instead, the process of FIG. 5 accesses and uses part (or all) of the email engine on the memory module (step 212) whenever the email engine is needed.

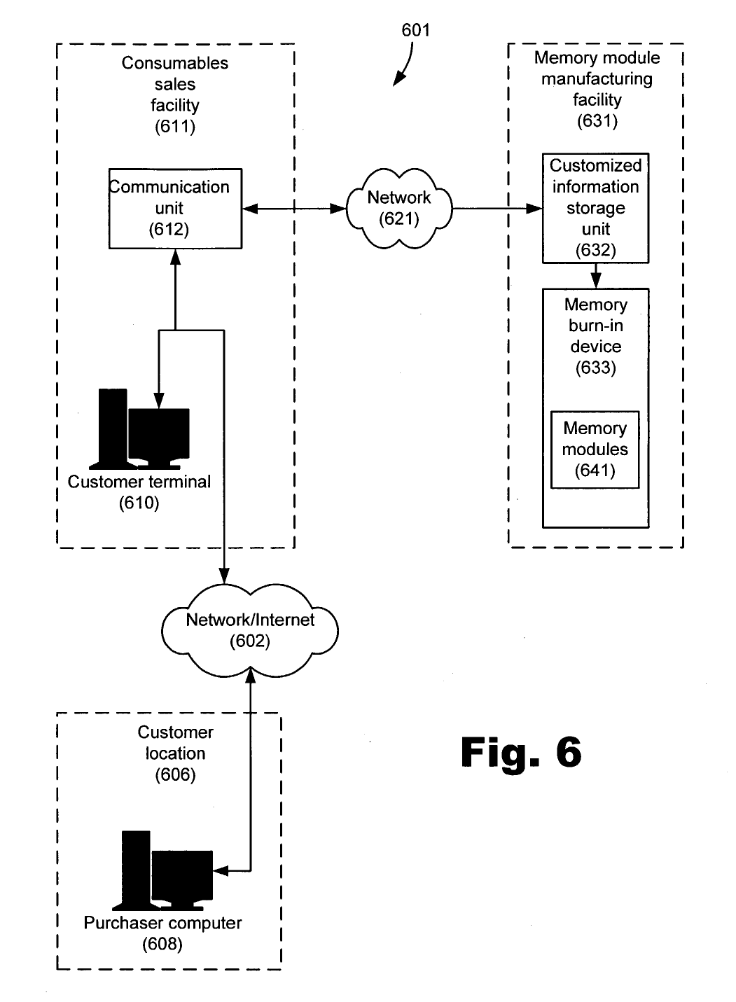

FIG. 6 is a block diagram illustrating a system for customizing email engines on memory modules. As indicated above, a memory module (110) may include recipient email address (107, FIG. 1) and pre-written email messages (106, FIG. 1) that a user or attendant would need or want to receive. The memory module (110) may also include a number of selectable or default trigger events that relate to the pre-written email messages. Different purchasers of a printing device consumable may want different pre-written email messages to be available for different trigger events and will likely want those messages addressed to particular recipients within the purchaser's organization or at a contactor serving the purchaser.

Thus, FIG. 6 illustrates a system with which a consumable purchaser can have the pre-written email messages (106, FIG. 1) and/or the recipient email addresses (107, FIG. 1) customized on a memory module (110, FIG. 2) that is affixed to the consumable (120, FIG. 2) being purchased. The system of FIG. 6 can also allow for the email engine (101, FIG. 1) to be customized or the version of the email engine to be selected so as to be compatible with the printing device of the purchaser.

As shown in FIG. 6, the system (601) may include components at up to three different locations: a customer location (606), a consumables sales facility (611) and a memory module manufacturing facility (631). There are a number of possible scenarios for a purchaser who wishes to buy printing device consumables with customized memory modules bearing an email engine.

For example, a purchaser may visit a sales facility (611). The sales facility (611) may include a customer terminal (610) into which a purchaser can enter the information to customize a memory module on a purchased consumable. For example, the purchaser, using the customer terminal (610) can select the version of the email engine, select or designate trigger events, enter pre-written email messages (106, FIG. 1) or recipient email address (107, FIG. 1). Alternatively, the purchaser could telephone, fax, email or otherwise transmit the information to the sales facility (611), whereupon sales facility personnel would enter the information into the terminal (610).

The information is then sent to a communication unit (612). The communication unit (612) transfers the information for customizing the memory module to a memory module manufacturing facility (631). The communication unit (612) may communication with the manufacturing facility (631) through a network (621). The network (621) may be a private or public network, and may include the Internet. The sales facility (611) and the manufacturing facility (631) may be at the same location or may be in different cities or even on different continents.

The information for customizing the memory module is stored in a data storage unit (632) until it is time to prepare the customized memory module. The information is then read into the system that forms the customized memory module, for example, a memory burn-in device (633). The burn-in device (633) then creates the customized memory module (641) desired by the purchaser by loading the desired data onto the memory module (641). The customized memory module (641) is then affixed to the ordered consumable and shipped to the purchaser.

In a different scenario, the purchaser need not visit the sales facility (611) to place an order for a customized memory module. Rather, the purchaser can use a computer (608) at the customer's location (606). For example, the purchaser, using the computer (608) can contact the communication unit (612) electronically. In one embodiment, the communication unit (612) includes a web server that the purchaser accesses through the Internet (602). The purchaser then inputs the information for customizing the memory module. This information is then transmitted to the communication unit (612), which may treat the information in the same manner as if entered through the customer terminal (610) at the sales facility (611). The information is then loaded to a customized memory module (641) as described above.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

What is claimed is:

1. A method of providing an email engine for a printing device, said method comprising attaching a memory module storing said email engine to a printing device consumable.

2. The method of claim 1, further comprising:
installing said printing device consumable in said printing device; and
interfacing said printing device and said memory module.

3. The method of claim 2, further comprising uploading said email engine from said memory module to a memory of said printing device.

4. The method of claim 3, further comprising executing said email engine with a controller of said printing device.

5. The method of claim 2, further comprising uploading an email engine interface to a memory of said printing device.

6. The method of claim 5, further comprising executing said email engine on said memory module through said email engine interface.

7. A method for generating email alerts from a printing device, said method comprising:
storing an email engine on a memory module;
attaching said memory module to a printing device consumable;
installing said printing device consumable with attached memory module in a printing device; and
uploading part or all of said email engine to a printing device memory.

8. The method of claim 7, wherein said printing device consumable comprises a toner cartridge.

9. The method of claim 7, further comprising sending an email alert with said email engine indicative of a condition of said printing device.

10. The method of claim 9, wherein said sending an email alert comprises:
monitoring operation of said printing device for occurrence of a trigger event; and
sending said email alert in response to said trigger event, wherein said email alert is specific to the trigger event detected.

11. The method of claim 10, further comprising receiving user input to specify a list of trigger events.

12. The method of claim 7, wherein said uploading part or all of said email engine to printing device memory comprises:
determining if a previous email engine already exists in said printing device memory; and
uploading said email engine to printing device memory if no previous email engine is found.

13. The method of claim 7, wherein said uploading part or all of said email engine to printing device memory comprises:
determining if a previous email engine already exists in said printing device memory; and
performing a replacement action if a previous email engine is found.

14. The method of claim 13, wherein said performing a replacement action requires an administration setting, password, or other form of authentication.

15. The method of claim 7, wherein said uploading part or all of said email engine to printing device memory comprises evaluating compatibility of said email engine with said printing device.

16. A method for generating email alerts from a printing device, said method comprising:
storing an email engine on a memory module;
attaching said memory module to a printing device consumable;
installing said printing device consumable with attached memory module in a printing device; and
uploading an email engine interface for said email engine to a printing device memory.

17. The method of claim 16, wherein said printing device consumable comprises a toner cartridge.

18. The method of claim 16, further comprising accessing said email engine on said memory module through said email engine interface.

19. The method of claim 18, further comprising sending an email alert with said email engine indicative of a condition of said printing device.

20. The method of claim 19, wherein said sending an email alert comprises:
monitoring operation of said printing device for occurrence of a trigger event; and
sending said email alert in response to said trigger event, wherein said email alert is specific to the trigger event detected.

21. The method of claim 20, further comprising receiving user input to specify a list of trigger events.

22. A method of customizing an email engine for use by a printing device, said method comprising:
receiving information from a purchaser of a printing device consumable;
storing said information with an email engine on a memory module attached to said printing device consumable.

23. The method of claim 22, further comprising providing said printing device consumable with said memory module to said purchaser.

24. The method of claim 22, wherein said receiving said information from a purchaser comprises receiving said information through a terminal at a consumables sales facility.

25. The method of claim 22, wherein said receiving said information from a purchaser comprises receiving said information from said purchaser through a computer network.

26. The method of claim 25, wherein said computer network comprises the Internet.

27. The method of claim 22, wherein said receiving said information comprises receiving email addresses to which email alerts regarding said printing device are to be sent.

28. The method of claim 22, wherein said receiving said information comprises receiving email messages to be included in email alerts regarding said printing device.

29. A consumable for use with a printing device, said consumable comprising:
a printing device consumable;
a memory module attached to said printing device consumable; and
an email engine stored on said memory module.

30. The consumable of claim 29, further comprising email messages stored on said memory module.

31. The consumable of claim 29, further comprising email addresses stored on said memory module.

32. The consumable of claim 29, further comprising a wireless interface for said memory module for interfacing and communicating with a printing device.

33. The consumable of claim 32, wherein said wireless interface comprises a radio frequency interface.

34. The consumable of claim 32, wherein said wireless interface comprises an infrared interface.

35. The consumable of claim 29, further comprising a wired interface for said memory module for interfacing and communicating with a printing device.

36. The consumable of claim 29, wherein said email engine comprises an email engine interface which, when uploaded to a printing device, allows access and use of said email engine on said memory module.

37. A printing device comprising:
a printing device controller;
a printing device memory; and
a printing device interface disposed and configured to interface and communicate with a memory module attached to a printing device consumable supplied to said printing device.

38. The printing device of claim 37, wherein said printing device interface comprises a wireless interface.

39. The printing device of claim 38, wherein said wireless interface comprises a radio frequency interface.

40. The printing device of claim 38, wherein said wireless interface comprises an infrared interface.

41. The printing device of claim 37, wherein said printing device interface comprises a wired interface.

42. The printing device of claim 37, further comprising a user interface for controlling said printing device.

43. The printing device of claim 37, wherein said memory module comprises an email engine stored thereon.

44. A printing device comprising:
means for controlling said printing device;
memory means in said printing device; and
interface means in said printing device that are disposed and configured to interface and communicate with a memory means attached to a printing device consumable supplied to said printing device.

45. The printing device of claim 44, wherein said printing device interface comprises a wireless interface.

46. The printing device of claim 45, wherein said wireless interface comprises a radio frequency interface.

47. The printing device of claim 45, wherein said wireless interface comprises an infrared interface.

48. The printing device of claim 44, wherein said printing device interface comprises a wired interface.

49. The printing device of claim 44, further comprising user interface means for controlling said printing device.

50. The printing device of claim 44, wherein said memory means comprise an email engine stored thereon.
